(19) United States
(12) Patent Application Publication
(10) Pub. No.: US 2016/0299876 A1
(43) Pub. Date: Oct. 13, 2016

(54) Dynamic Signature Box for a Digital Signature System

(71) Applicants: Rob D. New, Indianapolis, IN (US); Robert C. Cochrane, Indianapolis, IN (US)

(72) Inventors: Rob D. New, Indianapolis, IN (US); Robert C. Cochrane, Indianapolis, IN (US)

(21) Appl. No.: 14/684,387

(22) Filed: Apr. 12, 2015

(51) Int. Cl. G06F 17/21; H04L 29/06; G06F 17/24; H04L 9/32

(52) U.S. Cl. CPC G06F 17/212; H04L 9/3247; H04L 63/0457; G06F 17/242; G06F 17/214

(57) ABSTRACT

A system that allows a document to be sent to an authorized signer at a remote location for signature. The signer can manipulate a signature block or other indicator to anywhere on any page of the document on a handheld device like a smartphone. The signer can then authorize signature. A server or other central system can then fetch a digital replica of the signer's actual written signature and affix it to the document at the specified location. A new signer can enter a signature into the system remotely by photographing it with the handheld device and sending an encrypted version of it to the central location or server.

### BACKGROUND

1. Field of the Invention

The present invention relates generally to the field of digital signature systems and more particularly to a High Volume Digital Signature System (HVDSS) having a dynamic signature block that can place a signature anywhere on a document.

2. Description of the Prior Art

Digital signature systems are known that allow different types of authorizing signatures to be associated with, or placed on, documents. Some of these signatures are totally electronic in the form of a coded binary sequence the merely represents a signature or authorization. A particular class of electronic signatures are replicas of actual handwritten signatures that are stored in either analog or digital form.

One example of a prior art digital signature system that uses handwritten signatures is the system taught by Appelbaum et al. in U.S. Pat. No. 8,667,290. In this system, signers write their names on paper registration forms. These forms are then scanned, and the signature is stored in a signature database. This system is used exclusively with a closed universe of authorized signers (such as a group of doctors in a medical network). When a user (hospital) wants to obtain an authorizing signature on a particular document, a physical label is placed on the document at the location where the signature will later reside. The document and label is then scanned and transmitted to the signer along with a request to authorize use of his or her pre-stored signature, i.e. to approve the document. If the signer approves the document, the hospital or other enterprise system places the stored replica of the signature on the electronic version of the document at the location where the label was attached.

A great disadvantage of these prior art systems is the necessity of a closed universe of trusted signers. Another great disadvantage is the inability of the signer to control the location on the document where their signature appears, and the need for the originator to place a label on the physical document to indicate the signature location.

It would be tremendously advantageous to have a signature system that allowed an open universe of users, where new users could register very simply using handheld electronic devices such as smartphones, and then when signing (authorizing signature), could place their signature where they want it on the document using their handheld device. Such a system should be able to handle arbitrary documents (not just templates or canned forms) with the signature location being anywhere on the document. Such a system should be able to handle entirely electronic documents without the necessity of any type of labels or label placement on the part of the originator.

### SUMMARY OF THE INVENTION

The present invention relates to features of a High Volume Digital Signature System (HVDSS) that allows arbitrary subscribers to register their signatures in the system remotely using a smart handheld electronic device. The system improves the efficiency of obtaining and using digital signatures in all types of commercial settings including medical, education, real estate, law and any other type of business that requires signatures on documents.

In one embodiment, the present invention allows remote capture of a new user's signature from a photograph of the signature taken using the camera on the user's handheld device. The photograph of the signature is transmitted to a remote server and converted to a digital replica of the handwritten signature. The digital representation, and other user data associated with the signature, is stored in a database for that user. Identification information for the user's handheld device can also optionally be stored to prevent the use of the signature from some other device. Any registered user can then use the system to sign any document remotely. All communication in either direction between the user device and the server is typically encrypted for security. The digital signature and stored documents are also typically encrypted.

A second registered user (with or without a stored signature) can then present a document to the system for signature by other registered user. An encrypted version of the document is sent to the signer's electronic device along with a request to sign (authorize) the document. The signer can read or browse the document on their handheld device, and when ready to sign, simply manipulate a signature box or other indicator on one of the document's pages to the desired location on the page for the signature. This can be done by simply dragging the signature box to the correct signing location on the page. The signer can then simply touch or click an authorize button. The signature is automatically affixed at the server to the electronic version of the document along with a date/time code and other transaction identifying and verifying information. In the event that the signer declines authorization, he or she is allowed to enter a reason. The signed or unsigned document is then returned to the originator. If unsigned, the reason for denial is also returned.

### DESCRIPTION OF THE FIGURES

Attention is directed to several figures that illustrate features of the present invention:

FIG. 1 is a system block diagram of a High Volume Digital Signature System including an embodiment of the present invention.

FIG. 2 shows an alert screen on a handheld device.

FIG. 3 shows a screen that contains user choices including an inbox.

FIG. 4 shows a screen on a handheld device containing a portion of a document and a movable signature container or indicator.

FIG. 5 shows the screen of FIG. 3 after the user has moved the signature container to a new position.

FIG. 6 shows the screen of FIG. 4 after the user has authorized affixation of an authorized signature.

FIG. 7 is a message flow diagram of an embodiment of the present invention.

Several drawings and illustrations have been presented to aid in understanding the present invention. The scope of the present invention is not limited to what is shown in the figures.

### DESCRIPTION OF THE PREFERRED EMBODIMENTS

The present invention relates to a High Volume Digital Signature System (HVDSS) that allows anyone to register their signature by simply photographing it or otherwise entering it. A registered signer receiving a document to be signed on a handheld device can position their signature anywhere on the document. The system is thus a method for rapidly and securely converting a document from an unsigned state to a signed state from a remote location

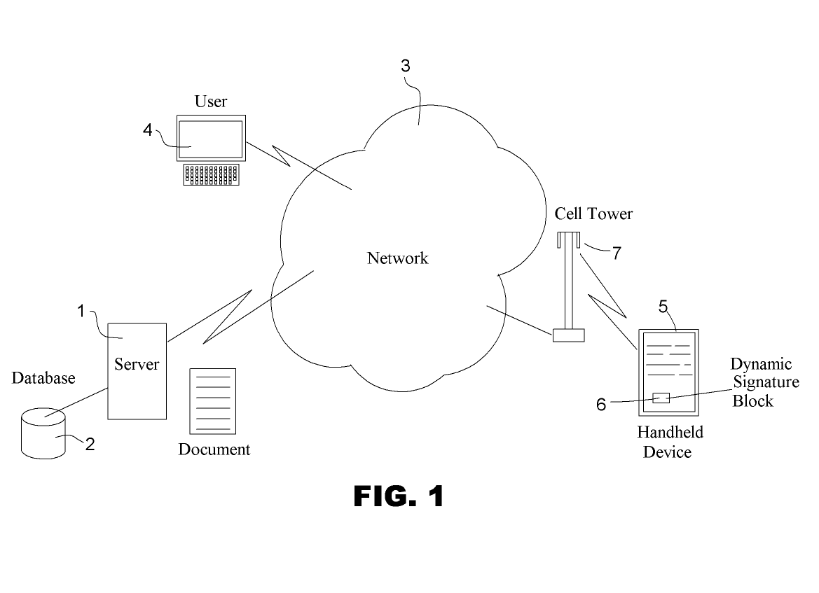

FIG. 1 shows a block diagram of part of an HVDSS. A server 1 with access to a database 2 operates over a network 3 and is in communication with several user computers 4 and several to many handheld devices 5. The handheld devices 5 can communicate over a cellular network using base station towers 7 or can communicate using WiFi or any other wireless access method.

A user at a user computer 4 may have a document that needs signing by a pre-verified signer. As an example, the user may be at a hospital and need an order authorized by a particular doctor. That doctor, as a registered user of the system, has previously entered a digital version of his or her signature. This can be a digitized photograph of the signature or other replica of the signature that is stored in the database 2 or elsewhere. The particular doctor may not be physically present at the hospital at the time the order needs to be signed. The user prepares the document and transmits it to the server 1 with a request that it be signed by the particular doctor. The server accesses the address of the doctor's smartphone or other handheld device and notifies the doctor's handheld device 5 that there is a document waiting to be signed. A priority such as “Urgent” or “Routine” may be assigned to the transaction. Typically, the handheld device contains a downloaded application (App.) that acts as an interface into the system.

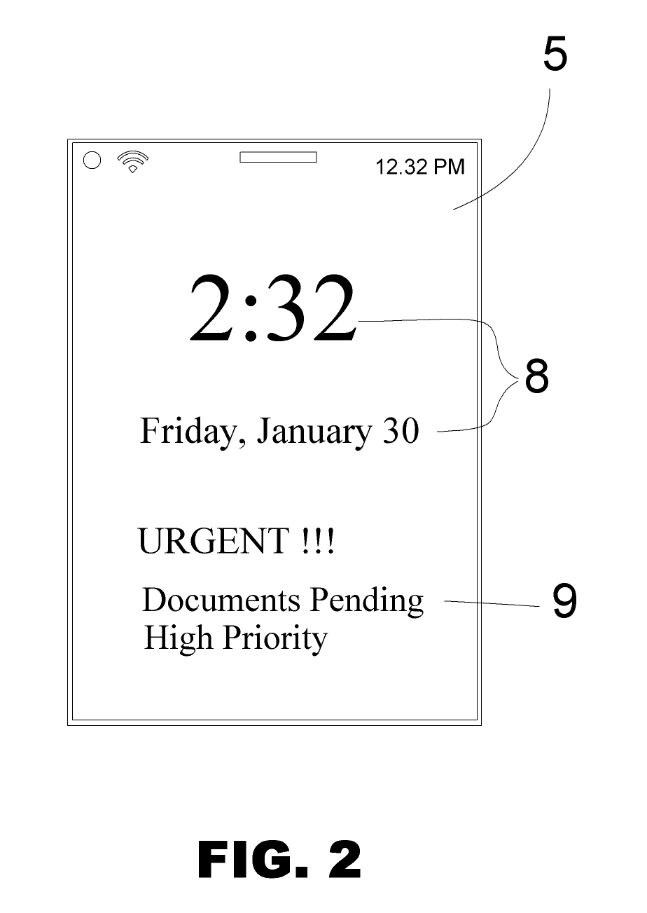

As can be seen in FIG. 2, the doctor's (or any authorized signer's) handheld device 5 can be notified that there is a new document. This can be done by causing the handheld device to produce an audio beep or the like, or a text message may be received or any other notification. The App. on the handheld device will then display an alert screen that can state the time, date 8 and priority 9 of the document to be signed.

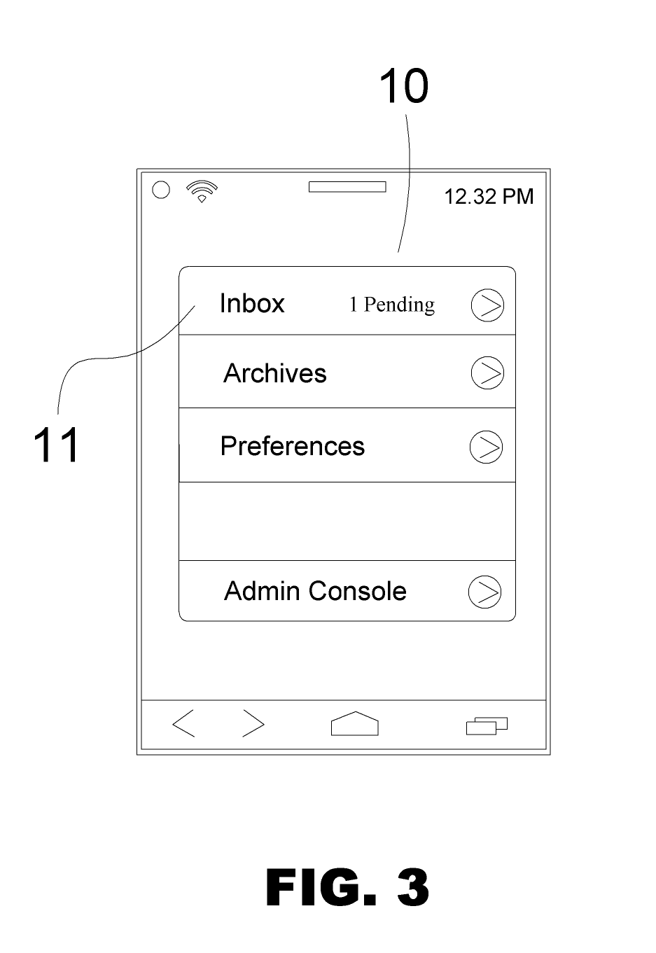

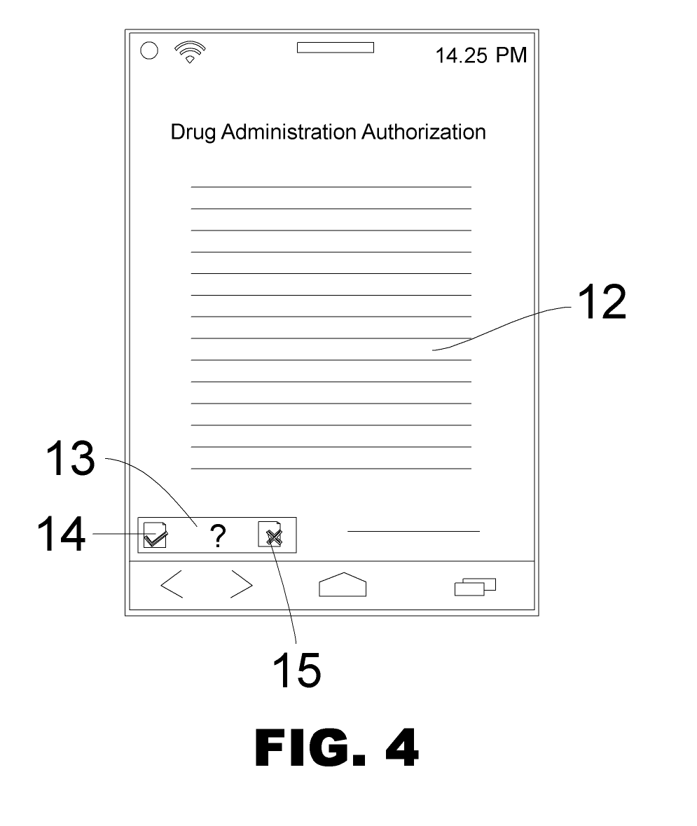

The signer can then simply touch the screen to pass through a logon page (not shown) and to a menu 10 containing a tab to an inbox. This can be seen in FIG. 3. The inbox tab 11 can list the number of pending documents waiting for signature. Upon touching the inbox tab, the signer can pick a particular document out of the inbox to read and possibly sign. A document 12 is shown in FIG. 4 filling the screen. If the document is too large to be conveniently read on a single screen, it can be magnified and scrolled, and subsequent pages can be selected using standard screen touch gestures or voice commands.

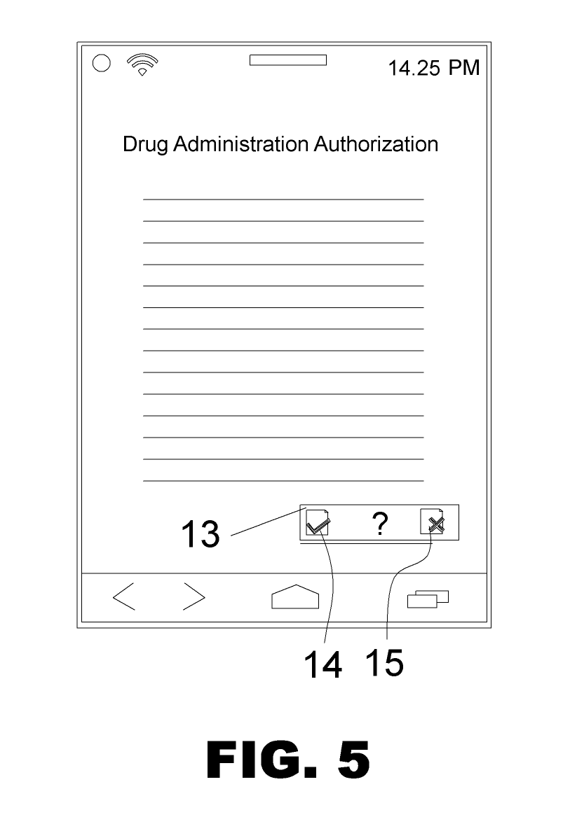

FIG. 4 also shows a signature block or container 13 located at the bottom of the document. This signature block contains an authorization button or icon 14 and a disapproval button or icon 15 (denial). This block 13 can appear on every page of the document if the user is reading an multi-page document. The user can then move the signature block 13 to any desired location on the page. FIG. 5 shows the signature block 13 moved to a location for signing at the right hand bottom of the last page of the document. The block 13 can be moved from the bottom of the signature page (or elsewhere) to any desired location on the page by dragging it in a standard way. When the block is positioned, the user can sign the document by touching or otherwise activating the approve button or icon 14 or can disapprove by touching the disapprove button or icon 15. If the user disapproves, he or she can be asked to state the reason.

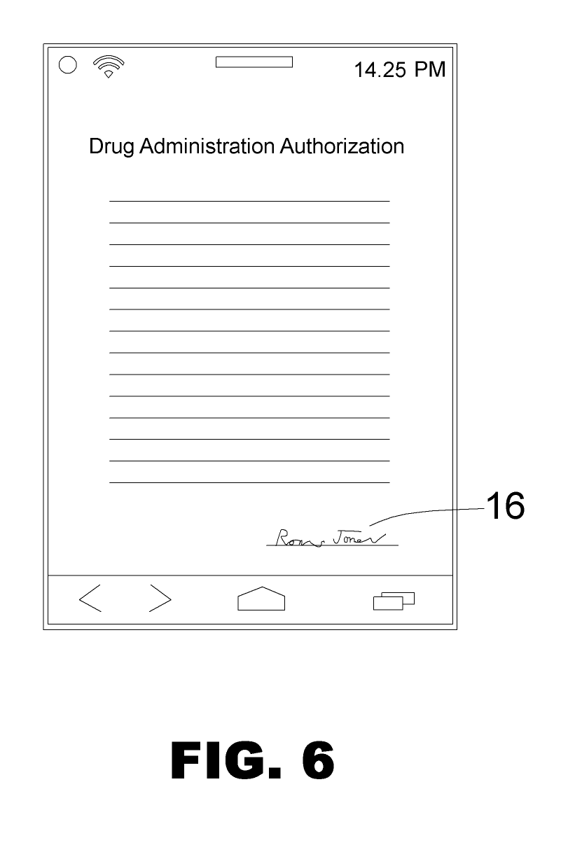

As soon as the user touches the approve button 14, a message is sent to the server and the appropriate signature replica is fetched and placed on the document at the desired location. The replica of the actual signature 16 can also appear on the screen as shown in FIG. 6 so the signer knows that the transaction is complete. At the same time, the server sends a copy of the signed document to the originator. The signature can also optionally include date/time information along with other security devices such as a hash code or other secure code to uniquely identify the transaction. For example, a hash can be created from the digital signature along with the date/time and possibly a transaction number or any other available transaction data. When the authorization is returned, a master copy of the signed document along with any transaction history and security codes can be stored in one or more databases.

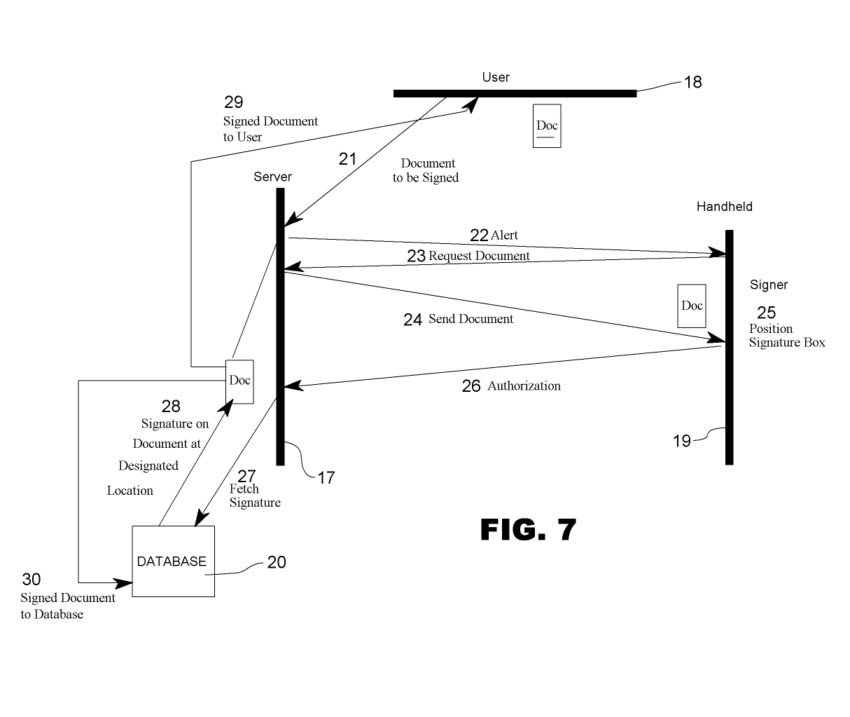

FIG. 7 shows a block diagram of an embodiment of the present invention including a handheld electronic device 19 such as a smartphone, a server 17 and a user 18 at any type of computer, laptop, tablet or handheld device. The handheld devices, and server each contain processors that execute stored instructions as well as memory devices that can store data. The stored instructions are stored in memory devices and on disks (at the server). The sever 17 typically has communication with a database 20 that can be co-located with the server, or can be remote. The entire system can be in what is known as the “cloud”. The database may be stored across disk drives or any other type of storage device. All devices in the system communicate over one or more networks. The network can include the public Internet and any type of private or local network both wide-area and local. The networks use firewall devices for protection as well as numerous switches, routers, load balancers and other devices. Physical network communication can be via wire, cable, fiber optic, wireless or by any other method. Wireless techniques include use of the cellular telephone system along with other wide or narrow band networks. Wireless techniques such as WiFi, BLUETOOTH, 2G-5G or other cellphone and any other wireless technique may be used.

A user or document originator 18, for example a subscriber broker, needs a signature on a document from a buyer. The originator 18 knows that the desired signer buyer is also a member who has an authorized signature stored in the system. In the alternative, the broker can have the desired signer download a simple App. to a smartphone 19, possibly pay a small membership fee, photograph their signature by direction from the App., and then become a member with a stored authorized signature by registering the signature. Anyone can become a registered member. There is no necessity for a closed universe of members or subscribers.

The originator 18 either creates the original document, or requests a stored copy of a blank document from the server 17. If the user 18 creates a new document, he or she sends a copy of it (which will later become the stored, signed master copy) to the server. The originator 18 then sends a request 21 over the network to the server 17 for signature by a particular authorized member. The server checks the database 20 to see if the requested party is indeed a member, and if there is a stored, authorized signature for that party in the database. In some embodiments, the server can check if the member is authorized to sign that type of document, or even that particular document. If the desired signer is a member with a stored signature, and authorized, the server 17 sends an alert 22 to the signer's handheld device 19. A previously downloaded App. on the handheld device can beep or otherwise notify the signer that there a new document to be signed. The signer typically logs in and selects the title of the document from an inbox as previously discussed. The signer's handheld device 19 then requests 23 the entire document from the server 17. The server sends 24 a copy of the document to the signer's handheld device 19, where the signer can read it or browse it page by page using the downloaded App.

After the signer has read the document and decided to sign it, the signer positions 25 the signature box anywhere on any page of the document (usually at the typical signature location on the last page—however, anywhere else on any page is within the scope of the present invention). The signer then activates the authorize button or icon which sends an authorization message 26 from the handheld 19 to the server 17. Upon receipt of the authorization message 26, the server 17 queries 27 the database 20 to fetch the digital version of the signature. The signature is then affixed 28 to the copy of the document at the server 17 and the signed document is sent 29 to the originator 18 and optionally back to the signer. In addition, the signed copy of the document is archived 30 in the database 20.

In the case where the signer decides to not sign the document, the reject button or icon is activated. The signer is then presented with a screen that allows entry of the reason for not signing. A reject message 31 is sent to the server 17, and the user is notified of the rejection and the reason. In either case, an archived record of the entire transaction can be preserved at the server.

The scenario shown in FIG. 7, and described above, is an example of one embodiment of the present invention. There are many other ways that the system can be coded and realized. As to the movable signature block, any display manipulation technique or application interface (API) that can return the x-y coordinates of a movable box or container to an application program can be used to position the signature on the document.

The same App. that reads documents and authorizes signatures can also be used to enroll new subscribers and signers. For example, a new subscriber can navigate to a system webpage and download the App. in a manner that is known in the art. This could optionally require payment of a small fee. The App. can inquire if the new subscriber wishes to store a signature. If so, the new signer can be directed to write his or her signature on a blank piece of paper. The App. can then instruct the new signer to photograph the signature, either under control of the App. or simply using the existing camera support supplied with the handheld device. Then the App. can encrypt and transmit the new digital replica of the signature to the server for storage in the database along with enrollment information. The database can also optionally store unique identifying information about the signer's handheld device (such as the ESN or other identifying information). For extra security, the system could optionally only accept a signature authorization or send a document to that particular phone. This feature can be used for high security situations.

It should be noted that all communication in the system can be (and typically should be) encrypted. Any method or type of encryption is within the scope of the present invention. For maximum security, the encryption is preferably provided at the application layer by the system and the App. on the handheld device and the application software at the sever without resorting to standard system encryption techniques such as https, IPSec or the like. However, these techniques can be used if desired, or any of them can be used as a second layer of encryption. For example, a particular signer may be operating over a virtual private network (VPN) with the server or central control location. In this case, the VPN would be using IPSec, and the sever and App. would further encrypt with an application level encryption technique. Keys can be exchanged by known techniques such as using public and private keys, certificates and the like.

For extra security, encrypted digital signatures, and documents can be stored separately from their keys. This is especially useful when the storage is in a cloud, since the absolute security of cloud storage is not certain. For example, an encrypted digital replica of a handwritten signature can be stored in one cloud, while its encryption key is stored in a separate cloud. For very high security, the stored keys can themselves be encrypted using a second key that is available when it is needed. For example, a secure signed document can be encrypted and stored in a first cloud. The encryption key (key 1) can be itself encrypted using a second key (key 2) and stored in a second cloud. Key 2, needed to decrypt key 1, can be stored with the document in the first cloud or elsewhere. While very secure, this method can in some cases slow down data or key access depending upon the robustness of communication with the clouds.

Digital replicas of handwritten signatures can take different forms. A particularly simple way is to simply store an encrypted bitmap or encrypted compressed map of the scanned signature. For additional security, the map of the scanned signature can specially coded with a non-standard code. The digital replica of the handwritten signature may also contain embedded security features such as hash codes, bits that identify the signer, the date signed, the duration of signature validity or the like. Such extra bits can optionally be stored in low order bits or in specially data fields.

Dynamic resizing of the signature may also be used since the original signature size may not be suitable of all situations. This can be done automatically by the system to match the requirements of a particular document, or in some embodiments can be performed by the signer by enlarging or diminishing the signature block on the handheld device.

Several descriptions and illustrations have been presented to aid in understanding the present invention. One with skill in the art will realize that numerous changes and variations can be made without departing from the spirit of the invention. Each of these changes and variations is within the scope of the present invention.

1. A method for securely and reliably changing the state of an electronic document from unsigned to signed using a handheld device comprising:
authorizing a user to electronically sign documents by requiring the user to photograph their signature using a first handheld device having a camera creating a photograph of the signature;
requiring the user to become a registered user by sending the photograph of the signature over a network from the first handheld device to a server where a digital replica of the photograph is stored in a database along with identification information of the registered user creating a stored digital replica of the signature and authorizing the registered user to sign documents;
the registered user later receiving a digital copy of a document to be signed on either the first handheld device or another handheld device, the digital copy of the document being first encrypted, transmitted over a network from a remote location, and decrypted on the handheld device, the document being in an unsigned state;
displaying one or more pages of the document on the handheld device;
displaying a signature location container superimposed on each page of the document;
permitting the registered user to reposition the signature location container to a chosen position on any page of the document;
accepting an authorization from the registered user to place the stored authorized digital replica of the signature on the document at a chosen position on a chosen page;
transmitting the authorization, chosen page and chosen position over the network from the handheld device to the remote location;
fetching the stored digital replica of the signature from the database at the remote location or transmitting it to the remote location;
affixing the digital replica of the signature onto the electronic document at the chosen position converting the electronic document to a signed state.

2-4. (canceled)

5. The method of claim 1 wherein the signature location container is a movable signature box.

6. The method of claim 1 further comprising allowing the registered user to deny authorization and to enter a reason for denial.

7. The method of claim 1 further comprising printing a hardcopy of the document in the signed state including the digital signature at the chosen location.

8. A method for transforming a stored electronic document from an unsigned state to a signed state comprising:
authorizing a user to remotely sign documents by requiring the user to photograph their signature using a digital camera in a handheld device creating a photograph of the signature;
requiring the user to become a registered user by sending the photograph of the signature over a network to a server where a digital replica of the photograph is stored in a database along with identification information of the registered user creating a stored digital replica of the signature and authorizing the registered user to sign documents;
a signature requesting user transmitting a copy of the stored electronic document to the registered user at a remote location, the registered user receiving the document on a handheld device;
displaying at least part of the document along with a movable signature location indicator on the handheld device;
allowing the registered user to move the signature location indicator to a chosen signature position on any page of the document;
accepting a command on the handheld device to affix the stored digital replica of the signature on the document at a chosen signature position on a chosen page;
affixing the stored digital replica of the signature on the electronic document converting the document from an unsigned state to a signed state.

9. The method of claim 8 further comprising printing the electronic document in the signed state.

10. (canceled)

11. The method of claim 8 further comprising accepting a signature denial and a reason for denial.

12. The method of claim 11 wherein the document remains in the unsigned state and the signature denial and reason for denial is communicated to the signature requesting user.

13. The method of claim 11 wherein all communication is encrypted.

14-18. (canceled)

19. A method for securely and reliably changing the state of an electronic document from unsigned to signed using a particular handheld device comprising:
authorizing a user to electronically sign documents by requiring the user to photograph their signature using a first handheld device having a camera creating a photograph of the signature;
requiring the user to become a registered user by sending the photograph of the signature over a network from the first handheld device to a server where a digital replica of the photograph is stored in a database along with identification information of the registered user and information uniquely identifying the first handheld device thus creating a stored digital replica of the signature and authorizing the registered user to sign documents using the particular first handheld device;
the registered user later receiving a digital copy of a document to be signed on the first handheld device, the document being in an unsigned state;
displaying one or more pages of the document on the first handheld device;
displaying a signature location container superimposed on all pages of the document;
permitting the registered user to reposition the signature location container to a chosen position on any page of the document;
accepting an authorization from the registered user to place the stored digital replica of the signature on the document at a chosen position on a chosen page;
transmitting the authorization, chosen page and chosen position over the network from the first handheld device to the remote location;
fetching the stored digital replica of the signature from the database at the remote location or transmitting it to the remote location;
affixing the digital replica of the signature onto the electronic document at the chosen position on the chosen page converting the electronic document to a signed state.
